(19) United States
(12) Patent Application Publication
(10) Pub. No.: US 2005/0035702 A1
(43) Pub. Date: Feb. 17, 2005

(54) Shadow mask for cathode ray tube and manufacturing method thereof

(76) Inventors: Sang Mun Kim, Gumi-si (KR); Sung Yeon Kim, Gumi-si (KR); Dong Seok Kim, Changwon-si (KR)

Correspondence Address: BIRCH STEWART KOLASCH & BIRCH, PO BOX 747, FALLS CHURCH, VA, 22040-0747, US

(21) Appl. No.: 10/902,386

(22) Filed: Jul. 30, 2004

(30) Foreign Application Priority Data
Aug. 14, 2003 (KR) 10-2003-0056616

(51) Int. Cl. H01J 29/81; H01J 29/07; H01J 9/12

(52) U.S. Cl. 313/402; 313/403; 445/47; 445/36

(57) ABSTRACT

Disclosed is a cathode ray tube comprising a panel of which inner surface is coated with a fluorescent screen, a funnel connected to the panel, an electron gun housed in the funnel, emitting electron beams, a deflection yoke for deflecting the electron beams, and a shadow mask for discriminating the electron beams in colors, wherein the shadow mask is made of AK (Aluminum Killed) steel, a Fe—Ni alloy layer is deposited on at least one surface of the shadow mask, and an electron reflecting film is formed on the shadow mask opposed to the electron gun.

### BACKGROUND OF THE INVENTION

1. Field of the Invention

The present invention relates to a shadow mask for a cathode ray tube and manufacturing method thereof, more particularly, to a shadow mask for a cathode ray tube and manufacturing method thereof, in which an invar layer is formed on at least one surface of an AK (Aluminum Killed) shadow mask and an electron reflecting film is formed on the other surface of the shadow mask to oppose an electron gun, whereby deterioration of picture quality caused by a doming phenomenon can be resolved, and cost of manufacture can be reduced.

2. Discussion of the Background Art

FIG. 1 illustrates the structure of a related art cathode ray tube.

Referring to FIG. 1, the related art color cathode ray tube includes a panel 6 whose inner surface is coated with a fluorescent screen, a funnel 5 connected to the panel 6, an electron gun 1 embedded in the funnel 5, emitting electron beams, a shadow mask 8 formed on an inside of the panel 6, discriminating the electron beams in colors, a frame 7 for supporting the shadow mask 8, and a deflection yoke 2 attached to an outside of the funnel 5, deflecting the electron beams in horizontal and vertical directions.

When a video image signal is input to the electron gun 1 in the cathode ray tube with the above structure, thermion is emitted from a cathode of the electron gun 1, forming electron beams. This electron beam is accelerated and concentrated toward the panel 6 by the application of a voltage from each electrode of the electron gun 1.

The electron beams are then deflected by the deflection yoke 2 in the horizontal and vertical directions, and scanned to the inner surface of the panel 6.

The deflected electron beams pass through electron beam passing holes of the shadow mask 8, and are discriminated in colors. After being discriminated in colors, the electron beams collide with the fluorescent screen of the inner surface of the panel 6, causing emissions of fluorescent substances. At the end, an image signal is reproduced on the screen.

To protect the electron beams from the influence of a geomagnetic field en route to the fluorescent screen, an inner shield 3 is further included for shielding the geomagnetic field effect.

Only 30% of the electron beams pass through the electron passing holes of the shadow mask 8, and the rest 70% of the electron beams collide with the surface of the shadow mask 8, and are converged to heat energy.

The converted heat energy raises surface temperature of the shadow mask 8, and causes thermal expansion on the shadow mask 8. As a result thereof, the electron beams having passed through the electron beam passing holes of the shadow mask 8 are landed on a portion of the fluorescent screen other than the predetermined portion of the fluorescent screen, and a color broadening (or blurring) phenomenon, namely a doming phenomenon, appears on the screen.

A traditional method for controlling the doming phenomenon of the shadow mask 8 was changing a length of a mask spring for supporting the mask frame 7, and changing welding temperature.

However, the above methods were carried out at a completion point of the doming phenomenon following thermal expansion of the shadow mask 8, so they were incapable of obviating deteriorations of resolution caused by the early doming stage.

To solve the problem, U.S. Pat. No. 4,528,246 disclosed a shadow mask comprising Invar (Fe—Ni) steel.

Although the shadow mask made of Invar (Fe—Ni) steel was less expanded by heat, cost and manufacturing process involved were not attractive at all.

Moreover, European Pat. No. 0139379 disclosed a method for reducing thermal expansion of the shadow mask by applying lead or borate having a low thermal expansion coefficient to the surface of the shadow mask.

For preventing the doming phenomenon, there are several more methods being suggested, such as, coating the surface of the shadow mask with insulating materials from a ceramic group having a high adiabaticity, spraying heat insulating materials, heat-radiating materials, or electron reflecting materials to the surface of the shadow mask or the surface of the electron gun.

However, part of the slots on the surface of the shadow mask was often blocked up despite an extra caution with an adjustment of the spray process. Even when the shadow mask was manufactured by applying the above methods, the coating surface was not smooth or even. Especially, a sputtering method had a number of problems in that a surface-covering layer got thin, deposition equipment was very expensive, and manufacture efficiency was pretty low.

### SUMMARY OF THE INVENTION

An object of the invention is to solve at least the above problems and/or disadvantages and to provide at least the advantages described hereinafter.

Accordingly, one object of the present invention is to solve the foregoing problems by providing a shadow mask for a cathode ray tube and manufacturing method thereof, in which an invar layer is formed on at least one surface of an AK (Aluminum Killed) shadow mask and an electron reflecting film is formed on the other surface of the shadow mask to oppose an electron gun, whereby deterioration of picture quality caused by a doming phenomenon can be resolved, and cost of manufacture can be reduced.

The foregoing and other objects and advantages are realized by providing a cathode ray tube comprising a panel of which inner surface is coated with a fluorescent screen, a funnel connected to the panel, an electron gun housed in the funnel, emitting electron beams, a deflection yoke for deflecting the electron beams, and a shadow mask for discriminating the electron beams in colors, wherein the shadow mask is made of AK (Aluminum Killed) steel, a Fe—Ni alloy layer is deposited on at least one surface of the shadow mask, and an electron reflecting film is formed on the shadow mask opposed to the electron gun.

Another aspect of the invention provides a cathode ray tube comprising a panel of which inner surface is coated with a fluorescent screen, a funnel connected to the panel, an electron gun housed in the funnel, emitting electron beams, a deflection yoke for deflecting the electron beams, and a shadow mask for discriminating the electron beams in colors, wherein the shadow mask is made of AK (Aluminum Killed) steel, a Fe—Ni alloy layer and a Ni layer are deposited on at least one surface of the shadow mask, and an electron reflecting film is formed on the shadow mask opposed to the electron gun.

Another aspect of the invention provides a manufacturing method of a shadow mask for a cathode ray tube, the method including the steps of: forming electron beam passing holes on an AK (Aluminum Killed) steel shadow mask, and performing an annealing treatment for molding to the shadow mask; forming a Fe—Ni alloy layer on at least one surface of the shadow mask through plasma deposition; performing a heat treatment process and crystallizing the Fe—Ni alloy layer; forming an electron reflecting film on the shadow mask opposed to the electron gun; and molding the shadow mask and melanizing the molded shadow mask.

Another aspect of the invention provides a manufacturing method of a shadow mask for a cathode ray tube, the method including the steps of: forming electron beam passing holes on an AK (Aluminum Killed) steel shadow mask; forming a Fe—Ni alloy layer and a Ni layer on at least one surface of the shadow mask through plasma deposition; performing an annealing treatment process for molding to the shadow mask and crystallizing the Fe—Ni alloy layer; forming an electron reflecting film on the shadow mask opposed to the electron gun; and molding the shadow mask and melanizing the molded shadow mask.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the structure of a related art cathode ray tube;

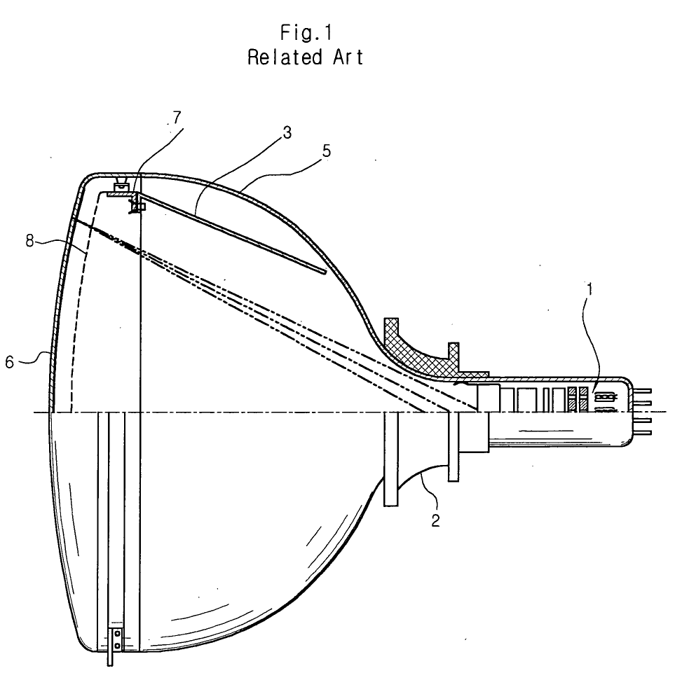

FIG. 2 illustrates a shadow mask in accordance with a first preferred embodiment of the present invention;

FIG. 3 illustrates a shadow mask in accordance with a second preferred embodiment of the present invention;

FIG. 4 is a graph showing a relation between nickel (Ni) content and thermal expansion coefficient of an alloy;

FIG. 5 illustrates analysis results of X-ray diffraction of a shadow mask according to a first preferred embodiment of the present invention, in which a 10 μm of Invar is deposited on the shadow mask and the shadow mask goes through a heat treatment for 13 minutes at different temperatures;

FIG. 6 illustrates analysis results of nickel (Ni) content of a 10 μm of Invar deposition film on a shadow mask according to a first preferred embodiment of the present invention, in which the surface of the shadow mask is covered with the 10 μm of Invar deposition film and the shadow mask goes through a heat treatment for 13 minutes at different temperatures;

FIG. 7 illustrates analysis results of X-ray diffraction of a shadow mask according to a second preferred embodiment of the present invention, in which a 10 μm of nickel Invar is deposited on the shadow mask and the shadow mask goes through an annealing heat treatment at 800° C.; and

FIG. 8 illustrates analysis results of nickel (Ni) content of a deposition film on a shadow mask after depositing nickel and Invar layers on the surface of the shadow mask and performing an annealing heat treatment on the shadow mask at 800° C.

### DETAILED DESCRIPTION OF PREFERRED EMBODIMENTS

The following detailed description will present a shadow mask for a cathode ray tube and manufacturing method thereof according to a preferred embodiment of the invention in reference to the accompanying drawings.

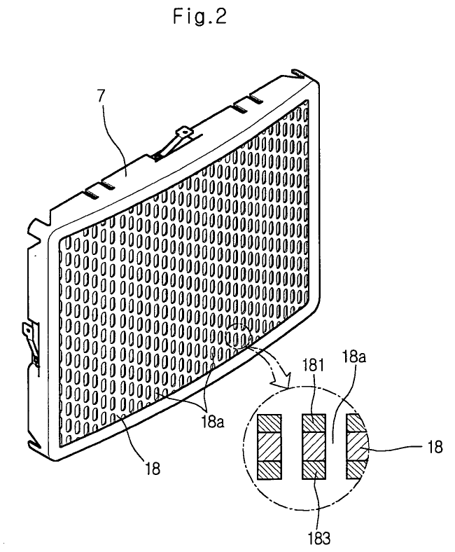

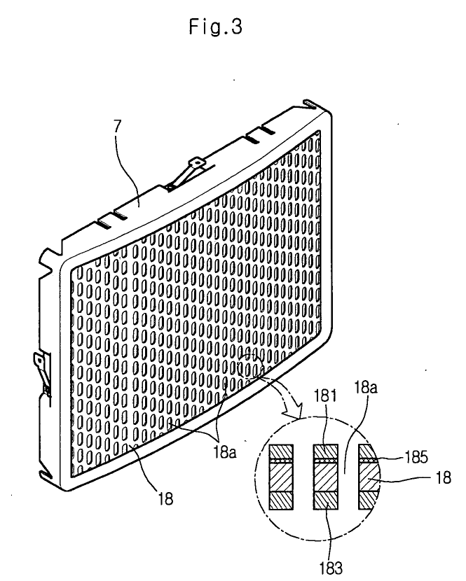

FIG. 2 illustrates a shadow mask in accordance with a first preferred embodiment of the present invention, and FIG. 3 illustrates a shadow mask in accordance with a second preferred embodiment of the present invention.

Referring to FIG. 2 and FIG. 3, an Invar (Fe—Ni) layer 181 is formed through plasma deposition on at least one surface an AK (Aluminum Killed) still shadow mask 18, and an electron reflecting film 183 is formed through a screen printing method on an opposite surface of an electron gun. Therefore, thermal expansion of the shadow mask can be lowered and an electron reflection effect is reinforced, thereby controlling a doming phenomenon.

Particularly, as for diminishing thermal expansion properties of the shadow mask, the present invention suggests two methods for forming the Invar (Fe—Ni) layer 181 through plasma deposition on at least one surface of the AK steel shadow mask 18.

According to a first embodiment, an annealing process for molding is performed on the shadow mask 18, and the Fe—Ni alloy Invar having 34-38% of Ni is deposited on at least one surface of the shadow mask 18. Through a crystallization heat treatment, the deposition film is crystallized, and the Invar (Fe—Ni) layer 181 is formed. Preferably, nickel (Ni) content of the deposition film should be in a range of 31-36%.

A manufacturing process of the shadow mask 18 according to the first embodiment of the invention is now explained below.

Before carrying out plasma deposition, an annealing treatment for molding is first performed on the shadow mask. In general, temperature for the heat treatment ranges 780-820° C. and the treatment continues about one hour.

Following the annealing treatment on the AK steel shadow mask 18, the Invar layer 181 is formed on the shadow mask through plasma deposition. At this time, the Invar contains Fe as a base, and 34-38% of nickel (Ni).

To crystallize the deposition film, the crystallization heat treatment is carried out. In this case, temperature for the heat treatment is in a rage of 630-700° C., and the heat treatment continues from 1 min to 1 hour.

If the heat treatment is ended within a minute, the deposition film is not yet crystallized. On the other hand, if the heat treatment continues longer than 1 hour, Ni element contained in the deposition film is diffused into the surface of the AK steel shadow mask 18, causing more difficulties with obtaining the same thermal expansion property with the Invar from the deposition film.

When the heat treatment temperature is raised, the thermal vibration-induced diffusion of atoms more easily occurs. Thus it is preferable to make the heat treatment relatively short. More preferably, the heat treatment can be done at 650° C. for 13 minutes.

According to a second embodiment, a nickel (Ni) layer 185 and an Invar (Fe—Ni) layer 181 are deposited in order, through plasma deposition, on at least one surface of an etched AK steel shadow mask 18. Afterwards, an annealing treatment for molding is conducted to crystallize the nickel layer 185 and the Invar (Fe—Ni) layer 181 at the same time.

Ni content of the deposition film is maintained in a range of 31-36%, to form a low thermal expansion coating film having Invar (Fe—Ni) alloy crystals.

A manufacturing process of the shadow mask 18 according to the second embodiment of the invention is now explained below.

The shadow mask 18 is first etched to form electron beam passing holes 18a thereon. The Ni layer 185 and the Invar layer 181 are deposited in sequence on one surface of the shadow mask 18, forming a multilayer deposition film. Later, the annealing treatment for molding is carried out.

Crystallization takes place during an 800° C. annealing heat treatment process, and Ni and Fe elements are diffused. Because of the diffusion, a low thermal expansion film is formed. Since the size of a Fe atom is almost the same with the size of a Ni atom, being 1.25 Å and 1.24 Å, respectively, both substitution and diffusion occur between two atoms.

Unlike the first embodiment, the second embodiment made the one-step heat treatment process, and thus, shortened the whole heat treatment process.

Formation of the Invar (Fe—Ni) alloy film based on the above two methods works for reducing thermal expansion properties of the shadow mask 18.

Plasma deposition will now be explained.

Plasma is a collection of charged or ionized gas containing about equal numbers of positive ions and electrons, and unionized atoms or molecules in a natural state. Applying electric, magnetic, and chemical properties of the plasma to vacuum deposition, one can manufacture a thin film with a compact structure and an excellent adhesiveness. Deposition of a metal film using this scheme is called ‘dry plating’.

Thusly formed deposition film through plasma deposition is as thick as 2-20 μm.

If the thickness of the deposition film is less than 2 μm, it costs too much time and expense to form that thin deposition film, so it is not practical. This is why a preferable thickness of the deposition film is of 2 to 20 μm.

Diffusivity of each element for estimating the degree of diffusion into the shadow mask 18 can be expressed by the following equation.

$$D = A exp ( - \frac{Q}{RT} ) \qquad [ Equation 1 ]$$

wherein, A denotes a constant, Q denotes an activation energy needed for diffusion, R is a gas constant, and T is temperature for heat treatment.

Concentration (dC) of Ni being diffused into the shadow mask 18 per unit time (dt) and per unit distance (dx) can be expressed in terms of diffusivity (D) and time (t) as follows:

$$\frac{ⅆ C}{ⅆ t} = \frac{ⅆ}{ⅆ x} ( D \frac{ⅆ C}{ⅆ x} ) \qquad [ Equation 2 ]$$

From the equations 1 and 2, it can be concluded that heat treatment temperature, heat treatment time, and concentration of Ni are main factors of diffusivity.

In the second embodiment of the invention, the deposition film undergoes the heat treatment at 800° C. for one hour, and is crystallized. To obtain a crystalline deposition film having the similar composition to the Invar, the Ni layer 185 is first deposited, and then the Invar (Fe—Ni) layer 181 is deposited next, forming the multilayer deposition film.

This is because when the deposition film is a single layer film, Ni content can be distributed unevenly, depending on a diffusion distance from the heat-treated surface to the inner surface of the shadow mask 18. Thus, it gets more difficult to get a similar composition to the Invar (Fe—Ni).

As discussed before, in the second embodiment of the present invention, the multilayer deposition film is first formed by depositing the Ni layer 185 and the Invar (Fe—Ni) layer 181 in sequence. Then, the multilayer deposition film went through heat treatment.

During the heat treatment process, Ni elements of the Ni layer 185 are diffused into the AK steel shadow mask 18 and the Invar (Fe—Ni) deposition layer 181.

The Ni elements diffused into the Invar (Fe—Ni) deposition layer 181 are again diffused into the AK steel shadow mask 18. In this way, it becomes possible to form a low thermal expansion alloy film similar to the Invar (Fe—Ni) having 31-60% of Ni.

One of important things here is that thicknesses of the Ni layer 185 and the Invar (Fe—Ni) layer 181 should be carefully chosen.

Suppose that a total thickness of the Ni layer 185 and the Invar (Fe—Ni) layer 181 is 20 μm. Then a ratio of the thickness of the Invar layer 181 to the thickness of the Ni layer 185 should be in a range of 1.5-4.

When the ratio is less than 1.5, Ni content of the deposition film after heat treatment is less than 31%, while when the ratio is greater than 4, Ni content of the deposition film becomes greater than 60%.

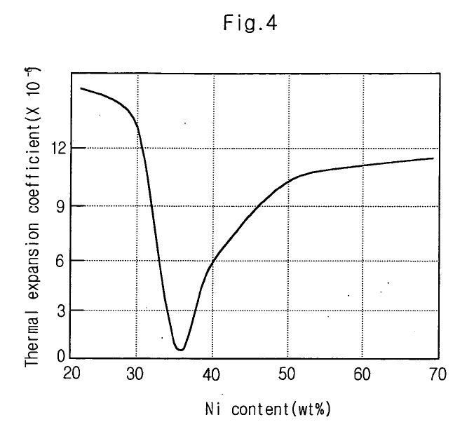

Accordingly, as shown in a graph of FIG. 4, illustrating a relation between Ni content and thermal expansion coefficient of the alloy, the thermal expansion coefficient of the alloy is pretty much similar to the thermal expansion coefficient of the AK steel shadow mask (i.e. 11.5-12.0×10⁻⁶). This means there is little advantage from deposition and heat treatment.

Preferably, the ratio of the thickness of the Invar layer 181 to the thickness of the Ni layer 185 should is 3.

Meanwhile, an electron reflecting film 183 is formed through a screen printing method on the surface of the shadow mask 18 to oppose the electron gun. A screen printing composition in this case is discussed below.

To form the electron reflection film 183, the screen printing composition is a mixture of 60-85 wt. % of electron reflecting materials like O₃ and Bi₂O₃ and an inorganic frit binder, and 15-40 wt. % of a vehicle.

If the total weight of the electron reflecting materials like O₃ and Bi₂O₃ and an inorganic frit binder (including PbO, heat-emitting materials and other additives) is greater than 85 wt. %, viscosity of the print composition is increased and thus, it gets difficult to do screen printing and adhesiveness is weakened. On the other hand, if the total weight is less than 60 wt. %, viscosity of the print composition is decreased and thus, the electron beam passing holes of the shadow mask can be blocked out during the screen printing process.

Therefore, the total weight of the electron reflecting materials like O₃ and Bi₂O₃ and an inorganic frit binder (including PbO, heat-emitting materials and other additives) should be in the range of 60-85 wt. %.

In addition, if less than 15 wt. % of the vehicle is used, viscosity of the print composition is increased, and thus, it gets difficult to do screen printing. On the other hand, if weight of the vehicle is greater than 40 wt. %, viscosity of the print composition is decreased and thus, the electron beam passing holes of the shadow mask can be blocked out during the screen printing process.

Thus, the vehicle content should be in a range of 15-40 wt. %.

In case of coating the shadow mask with the electron reflecting film 183 based on the screen printing method and applying the heat treatment to the shadow mask, the coating film preferably includes 30-70 wt. % of the electron reflecting materials like O₃ and Bi₂O₃ and 30-70 wt. % of the inorganic frit binder including PbO.

As for dissolving an organic binder composing the vehicle, a solvent having a volatilization point of 180-250° C. is used.

For example, butyl carbitol or butyl carbitol acetate can be used as the solvent. Also, butyl acetate can be used as an additive. Further, as for the organic binder, ethyl cellulose, nitro cellulose, or epoxy can be used.

A procedure for forming the electron reflecting film 183 is now explained below.

At first, the inorganic frit binder is added to the vehicle, and mixed together by a mixer. Then a roller is used to mix the mixture to manufacture the screen printing composition.

Thusly manufactured screen printing composition is applied to the shadow mask that has gone through the deposition process and the crystallization heat treatment, particularly to an opposite surface of the electron gun, and forms the coating film through the screen printing method.

As for the printing, a stainless plate or a silk plate can be utilized.

The coating film has a thickness of 2 to 10 μm. When the thickness is less than 2 μm, the electron reflecting film effect 183 is degraded. On the other hand, when the thickness if greater than 10 μm, the film can be peeled off.

After forming the electron reflecting film on the shadow mask 18, the shadow mask 18 is dried and molded. Finally, the molded shadow mask 18 is melanized at 600° C.

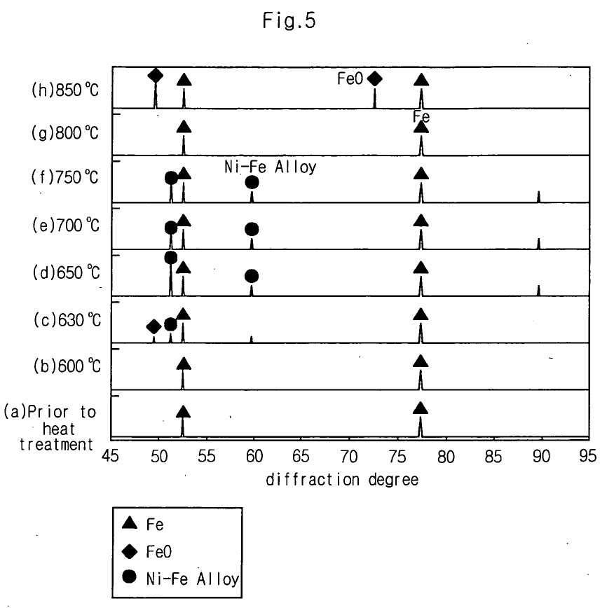

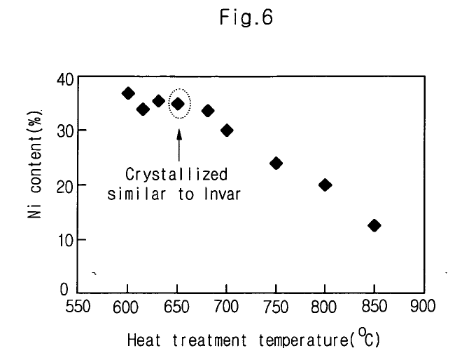

FIG. 5 illustrates analysis results of X-ray diffraction of a shadow mask according to the first preferred embodiment of the present invention, in which a 10 μm of the Invar is deposited on the shadow mask and the shadow mask goes through the heat treatment for 13 minutes at different temperatures, and FIG. 6 illustrates analysis results of nickel (Ni) content of the 10 μm of Invar deposition film on the shadow mask according to the first preferred embodiment of the present invention, in which the surface of the shadow mask is covered with the 10 μm of Invar and the shadow mask goes through the heat treatment for 13 minutes at different temperatures.

Table 1 below shows measurement results in thermal expansion coefficients of the AK steel shadow mask 18 coated with the 10 μm of Invar followed by the 13-minute heat treatment at 600° C., 630° C., 650° C., 680° C., 700° C., 750° C., and 800° C.

TABLE 1

| | Heat treatment temperature | Thermal expansion |
|---|---|---|
| | (° C.) | coefficient (×10⁻⁶) |
| (a) | 600 | 12.0 |
| (b) | 630 | 11.5 |
| (c) | 650 | 10.7 |
| (d) | 680 | 11.0 |
| (e) | 700 | 11.2 |
| (f) | 750 | 11.6 |
| (g) | 800 | 11.8 |

As shown in the above Table 1 and FIGS. 5 and 6, when the Invar deposition and crystallization processes are performed, an optimum heat treatment temperature interval with little diffusion of Ni is 630° C.-700° C. Especially, the thermal expansion property during the heat treatment was best at 650° C., and degree of crystallization and Ni content were also identical with those of the Invar.

Referring back to FIG. 5, prior to the heat treatment or at the 600° C. heat treatment, a diffraction peak of the Ni—Fe alloy is not shown because the Ni—Fe alloy is not yet crystallized. However, considering that the diffraction peak of the Ni—Fe alloy appears in the 630° C.-700° C. interval, the Ni—Fe alloy must be well crystallized in this interval. Especially, a maximum diffraction peak of the Ni—Fe alloy is found at 650° C., which means this is the very temperature where the Ni—Fe alloy is crystallized the most.

Also, in the 800° C.-850° C. interval, no diffraction peak of the Fe—Ni alloy is found. Realizing that the Ni content is reduced in the 800° C.-850° C. interval, as shown in FIG. 6, it can be concluded that Ni has been diffused into the AK steel, the Ni—Fe alloy is gone from the deposition film, and a Ni-containing AK steel crystalline material is produced.

In FIG. 5, a large X-ray diffraction peak value means a high degree of crystallization.

Referring to FIG. 6, the Ni content in the 630° C.-700° C. interval is about 36%, which is pretty close to the Invar material.

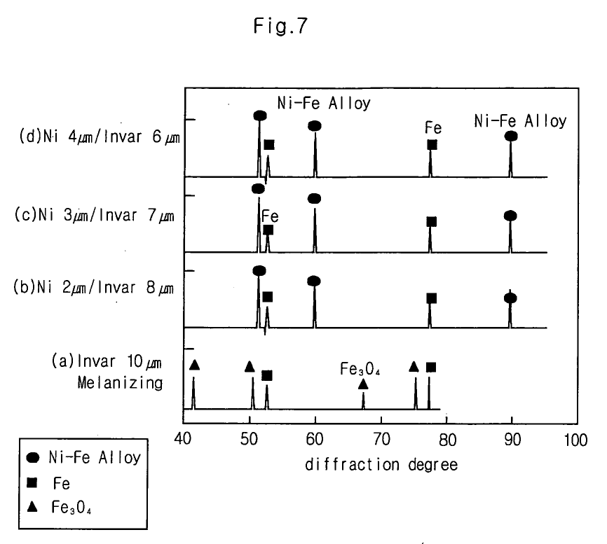

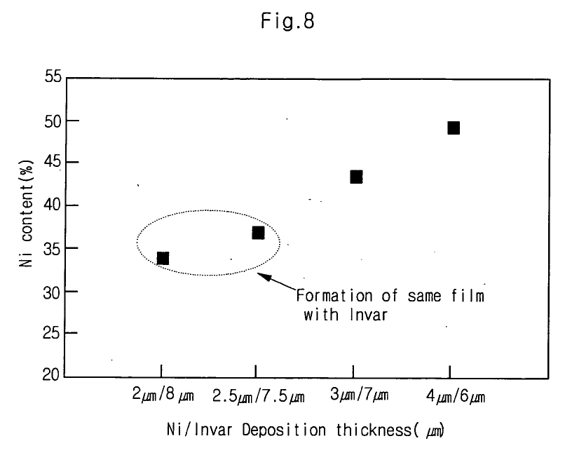

FIG. 7 illustrates analysis results of X-ray diffraction of the shadow mask according to the second preferred embodiment of the present invention, in which 10 μm of the nickel Invar is deposited on the shadow mask and the shadow mask goes through the annealing heat treatment at 800° C., and FIG. 8 illustrates analysis results of nickel (Ni) content of the deposition film on the shadow mask after depositing the nickel and Invar layers on the surface of the shadow mask and performing the annealing heat treatment on the shadow mask at 800° C.

Table 2 shows measurement results in thermal expansion coefficients of the AK steel shadow mask 18 coated with the Ni and Invar layers to the total 10 μm thickness, followed by the 1-hour heat treatment at 800° C.

TABLE 2

| | Thickness of | Thickness of | Thermal expansion |
|---|---|---|---|
| | Ni layer (μm) | Invar layer (μm) | coefficient (×10⁻⁶) |
| Comparison | 1 | 9 | 11.7 |
| Example 1 | | | |
| Comparison | 2 | 8 | 10.6 |
| Example 2(b) | | | |
| Comparison | 2.5 | 7.5 | 10.4 |
| Example 3 | | | |
| Comparison | 3 | 7 | 10.9 |
| Example 4(c) | | | |
| Comparison | 4 | 6 | 11.0 |
| Example 5(d) | | | |
| Comparison | 5 | 5 | 11.8 |
| Example 6 | | | |

As shown in the above Table 2 and FIGS. 7 and 8, when the total deposition thickness is designed to 10 μm and the ratio of the thickness of the Invar layer 181 to the thickness of the Ni layer 185 is 1.5-4, the thermal expansion coefficient is in a range of 10.6×10⁻⁶-11.0×10⁻⁶.

Considering that the thermal expansion coefficient of the AK steel is 11.5×10⁻⁶-12.0×10⁻⁶, a low thermal expansion deposition film whose thermal expansion coefficient is relatively lower than that of the AK steel can be obtained.

At this time, the Ni content is approximately 30-35%. Preferably, when the ratio of the thickness of the Invar layer 181 to the thickness of the Ni layer 185 is 3-4, the Ni content ranges 34-38%.

Also, when the ratio of the thickness of the Invar layer 181 to the thickness of the Ni layer 185 is 3-4, the Ni—Fe alloy is readily crystallized, and the X-ray diffraction analysis confirms that the peak value of the Ni—Fe alloy sensitivity is also found in this design condition.

Table 3 shows measurement results in doming of the first and second embodiments of the present invention and of the comparison example. Before getting into further explanation about Table 3, the first and second embodiments and the comparison examples 1 and 2 are explained first.

According to the manufacturing method of the shadow mask of the first embodiment, 10 μm of the Invar layer is deposited on the AK steel shadow mask 18 that has goes through the annealing treatment for molding and the heat treatment at 650° C. for 13 minutes. Then the screen printing composition using tungsten oxide is applied to the shadow mask opposed to the electron gun, and dried at 180° C. for 30 minutes.

According to the manufacturing method of the shadow mask of the second embodiment, 2.5 μm of the Ni layer and 7.5 μm of the Invar layer are deposited on the AK steel shadow mask 18, and the heat treatment is performed thereon at 800° C. for one hour. Then the screen printing composition using tungsten oxide is applied to the shadow mask opposed to the electron gun, and dried at 180° C. for 30 minutes.

According to the manufacturing method of the shadow mask used as the comparison example 1, after performing the annealing treatment to the AK steel shadow mask 18, the screen printing composition using tungsten oxide is applied to the shadow mask opposed to the electron gun, and dried at 180° C. for 30 minutes.

According to the manufacturing method of the shadow mask used as the comparison example 2, after performing the annealing treatment to the AK steel shadow mask 18, bismuth oxide is sprayed over the shadow mask opposed to the electron gun.

TABLE 3

| | | 2^{nd} | Comparison | Comparison |
|---|---|---|---|---|
| | 1^{st} Embodiment | Embodiment | Example 1 | Example 2 |
| Maximum | 55 μm | 49 μm | 58 μm | 61 μm |
| doming | | | | |

As shown in the above Table 3, when the Invar layer and then the electron reflecting film 183 are deposited on the surface of the shadow mask as in the first and second embodiments, doming is noticeably improved.

One of best advantages of the present invention is that Invar material effects can be obtained by using inexpensive AK steel, and this greatly reduces cost of manufacture. Also, because molding and crystallization can be simultaneously progressed through one step-thermal treatment, manufacturing process is shortened.

Moreover, the Invar layer deposited on one surface of the AK steel shadow mask, and the electron reflecting film on another surface of the shadow mask opposed to the electron gun. This structure particularly resolved the doming phenomenon.

Obtaining the Invar material effect by utilizing the inexpensive AK steel, cost of manufacture can be cut down.

Lastly, after the deposition of the Invar layer on the shadow mask, molding and crystallization are progressed at the same time through one-step heat treatment, thereby the manufacturing process is shortened overall.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A cathode ray tube comprising a panel of which inner surface is coated with a fluorescent screen, a funnel connected to the panel, an electron gun housed in the funnel, emitting electron beams, a deflection yoke for deflecting the electron beams, and a shadow mask for discriminating the electron beams in colors, wherein the shadow mask is made of AK (Aluminum Killed) steel, a Fe—Ni alloy layer is deposited on at least one surface of the shadow mask, and an electron reflecting film is formed on the shadow mask opposed to the electron gun.

2. The cathode ray tube according to claim 1, wherein the Fe—Ni alloy layer contains 31-36% of Ni.

3. The cathode ray tube according to claim 1, wherein the electron reflecting film contains 30-70 wt. % of electron reflecting materials and 30-70 wt. % of an inorganic frit binder.

4. The cathode ray tube according to claim 1, wherein the electron reflecting film contains O₃ and/or Bi₂O₃.

5. The cathode ray tube according to claim 1, wherein the electron reflecting film has a thickness of 2 to 10 μm.

6. The cathode ray tube according to claim 1, wherein the Fe—Ni alloy layer has a thickness of 2 to 20 μm.

7. A cathode ray tube comprising a panel of which inner surface is coated with a fluorescent screen, a funnel connected to the panel, an electron gun housed in the funnel, emitting electron beams, a deflection yoke for deflecting the electron beams, and a shadow mask for discriminating the electron beams in colors, wherein the shadow mask is made of AK (Aluminum Killed) steel, a Fe—Ni alloy layer and a Ni layer are deposited on at least one surface of the shadow mask, and an electron reflecting film is formed on the shadow mask opposed to the electron gun.

8. The cathode ray tube according to claim 7, wherein the Fe—Ni alloy layer contains 31-36% of Ni.

9. The cathode ray tube according to claim 7, wherein the Fe—Ni alloy layer is 1.5-4 times thicker than the Ni layer.

10. The cathode ray tube according to claim 7, wherein the electron reflecting film contains 30-70 wt. % of electron reflecting materials and 30-70 wt. % of an inorganic frit binder.

11. The cathode ray tube according to claim 10, wherein the electron reflecting film contains O₃ and/or Bi₂O₃.

12. The cathode ray tube according to claim 7, wherein the electron reflecting film has a thickness of 2 to 10 μm.

13. The cathode ray tube according to claim 7, wherein the Fe—Ni alloy layer has a thickness of 2 to 20 μm.

14. A manufacturing method of a shadow mask for a cathode ray tube, the method comprising the steps of:
forming electron beam passing holes on an AK (Aluminum Killed) steel shadow mask, and performing an annealing treatment for molding to the shadow mask;
forming a Fe—Ni alloy layer on at least one surface of the shadow mask through plasma deposition;
performing a heat treatment process and crystallizing the Fe—Ni alloy layer;
forming an electron reflecting film on the shadow mask opposed to the electron gun; and
molding the shadow mask and melanizing the molded shadow mask.

15. The method according to claim 14, wherein the Fe—Ni alloy layer contains 34-38% of Ni.

16. The method according to claim 14, wherein the heat treatment process to crystallize the Fe—Ni alloy layer is performed at a temperature of 630 to 700° C.

17. The method according to claim 14, wherein the heat treatment process to crystallize the Fe—Ni alloy layer is continued for 1 min-1 hour.

18. The method according to claim 14, wherein the electron reflecting film is formed through a screen printing method.

19. The method according to claim 18, wherein as for the electron reflecting film, a screen printing composition containing electron reflecting materials, 60-85 wt. % of an inorganic frit binder, and 15-40 wt. % of a vehicle is used.

20. A manufacturing method of a shadow mask for a cathode ray tube, the method comprising the steps of:
forming electron beam passing holes on an AK (Aluminum Killed) steel shadow mask;
forming a Fe—Ni alloy layer and a Ni layer on at least one surface of the shadow mask through plasma deposition;
performing an annealing treatment process for molding to the shadow mask and crystallizing the Fe—Ni alloy layer;
forming an electron reflecting film on the shadow mask opposed to the electron gun; and
molding the shadow mask and melanizing the molded shadow mask.

21. The method according to claim 20, wherein the Fe—Ni alloy layer is 1.5-4 times thicker than the Ni layer.

22. The method according to claim 20, wherein the Fe—Ni alloy layer is 3-4 times thicker than the Ni layer.

23. The method according to claim 20, wherein the electron reflecting film is formed through a screen printing method.

24. The method according to claim 23, wherein as for the electron reflecting film, a screen printing composition containing electron reflecting materials, 60-85 wt. % of an inorganic frit binder, and 15-40 wt. % of a vehicle is used.
